(19) United States
(12) Patent Application Publication
(10) Pub. No.: US 2025/0168643 A1
(43) Pub. Date: May 22, 2025

(54) System and Method for Detecting Rogue Devices and Implementing Security Measures on a Communications Network

(71) Applicant: CastNet, Inc., Nashville, TN (US)

(72) Inventors: Ty Roden, Fruitland Park, FL (US); Bartholomew Holzer, Nashville, TN (US)

(21) Appl. No.: 18/954,287

(22) Filed: Nov. 20, 2024

Related U.S. Application Data
(60) Provisional application No. 63/601,052, filed on Nov. 20, 2023.

(51) Int. Cl. H04W 12/122; H04W 12/06

(52) U.S. Cl. CPC H04W 12/122; H04W 12/06

(57) ABSTRACT

A system and method are disclosed for detecting rogue devices and implementing security measures on a communications network in a persistent manner. The system includes network monitoring devices that are connected to one or more communications networks. The overall process of the method begins by performing network and device discovery with the network monitoring devices. Each discovered device is classified if the network and device discovery is performed. Discovered devices are authenticated if the discovered device is classified as a supported device. Discovered devices are designated as unclassified devices if the discovered devices are not classified. A device risk level is assigned to each unclassified device. Security countermeasures are performed if the discovered devices are classified as unauthorized devices, or if the designated device risk level of the unclassified device exceeds a risk level threshold. Several iterations are performed to facilitate the persistent monitoring of the target communications networks.

### FIELD OF THE INVENTION

The present invention generally relates to security systems and communications networks. More specifically, the present invention discloses novel means to monitor wireless signals in communications networks to make decisions about what is present within the monitored network based on wireless-enabled devices databases from both open sources and private sources.

### BACKGROUND OF THE INVENTION

Technical Surveillance Countermeasures (TSCM), commonly known as bug sweeps, are generally performed by highly trained technicians who “sweep” an area for hidden electronic devices, also known as “bugs.” Bug sweeps are a common practice in the private sector and the government where there is a high risk of corporate and government espionage. Traditional TSCM is performed on a routine basis, often before major events. The issue with this method is that the sweep “clears” the target location at a specific point in time. If a bug is installed after the sweep is performed, the bug would not be detected. Complex espionage protocols can learn the schedule of bug sweeps and avoid detection by removing or temporarily shutting down the bugs when the bug sweeps are performed.

TSCM practitioners have long recognized the need for persistent monitoring, but the technical hurdles have been too great to overcome. In particular, the cost of monitoring equipment is often too high to be widely implemented. On the other hand, bugs have become more accessible due to different factors, such as the increased accessibility to high-speed Internet. The widespread availability of bugs have brought greater problems to the public and smaller businesses who often do not have the means to implement persistent monitoring. There is a need for novel TSCM solutions that address these concerns and provide ongoing monitoring capabilities to safeguard against unauthorized surveillance.

Therefore, an objective of the present invention is to provide a novel system and method for detecting rogue devices and implementing security measures on a communications network in a persistent manner. The system of the present invention monitors electronic devices connected on a communications network, such as computer networks and wireless networks, to continuously detect and locate electronic monitoring devices left in a location. Another objective of the present invention is to implement a system that manages several network monitoring devices, preferably referred to as sensors, at the target locations for persistent monitoring. The sensors of the present invention can be monitored from a centralized control center that allows remote management. Satellite sensors can be implemented for greater coverage of the target location and to allow the implementation of other features including, but not limited to, geolocation, direction finding services, intra-zone movement of detected devices, etc. Another objective of the present invention is to provide a system that accommodates different network adapters that facilitate the monitoring of different signals. The monitoring of different signals allows the detection of devices other than surveillance devices. Additional features and benefits of the present invention are further discussed in the sections below.

### SUMMARY OF THE INVENTION

The present invention discloses a system and method for detecting rogue devices and implementing security measures on a communications network in a persistent manner. The present invention enables the implementation of novel Technical Surveillance Countermeasures (TSCM) to detect rogue devices performing unauthorized actions in the network, such as performing unauthorized surveillance in the target location. In general, the present invention monitors wireless signals, such as the radio waves of Wi-Fi and Bluetooth, and compares the monitored data with known information about electronic devices that utilize such wireless signals. Based on this analysis, the present invention can make informed decisions regarding the presence of specific elements within the monitored area. To facilitate this functionality, the present invention maintains comprehensive databases that include information about wireless-enabled devices from both open and private sources.

Additionally, the present invention retains information on anticipated traffic patterns in the monitored communications network. By assimilating these details, the present invention acquires traffic heuristics for each monitored location, enabling the detection of anomalies effectively. Several security counteractions can be implemented including, but not limited to, alerting a security operations center, notifying the property owner, querying the device in question, disrupting the device's communications to render the device offline, if necessary, etc. Additional monitoring and countermeasure features are further discussed to improve the detection of rogue devices and the implementation of security measures.

### BRIEF DESCRIPTION OF THE DRAWINGS

FIG. 1 is a schematic view of the user interface of the control center of the present invention, wherein the organizations page is shown.

FIG. 2 is a schematic view of the user interface of the control center of the present invention, wherein an organization information page is shown.

FIG. 3 is a schematic view of the user interface of the control center of the present invention, wherein an organization user page is shown.

FIG. 4 is a schematic view of the user interface of the control center of the present invention, wherein an organization authentication page is shown.

FIG. 5 is a schematic view of the user interface of the control center of the present invention, wherein an organization device health page is shown.

FIG. 6 is a schematic view of the user interface of the control center of the present invention, wherein a discovery page is shown.

FIG. 7 is a schematic view of the user interface of the control center of the present invention, wherein a user profile page is shown.

FIG. 8 is a schematic view of the user interface of the control center of the present invention, wherein a case overview page is shown.

FIG. 9 is a block diagram of the overall system of the present invention.

FIG. 10 is a flowchart showing the overall process of the method of the present invention.

FIG. 11 is a flowchart showing the continuation of the overall process of the method of the present invention shown in FIG. 10.

FIG. 12 is a flowchart showing the subprocess of classifying discovered networks.

FIG. 13 is a flowchart showing the subprocess of manually classifying communications networks.

FIG. 14 is a flowchart showing the subprocess of monitoring and determining the network status of a discovered network.

FIG. 15 is a flowchart showing the subprocess of manually classifying electronic devices.

FIG. 16 is a flowchart showing the subprocess of assigning and monitoring an authorized zone for a discovered device.

FIG. 17 is a flowchart showing the subprocess of assigning risk levels to discovered devices.

FIG. 18 is a flowchart showing the subprocess of detecting the likely device type of the discovered device.

FIG. 19 is a flowchart showing the subprocess of determining the total confidence scores for each discovered device.

FIG. 20 is a flowchart showing the subprocess of monitoring and determining the network status of a discovered device.

### DETAIL DESCRIPTIONS OF THE INVENTION

All illustrations of the drawings are for the purpose of describing selected versions of the present invention and are not intended to limit the scope of the present invention.

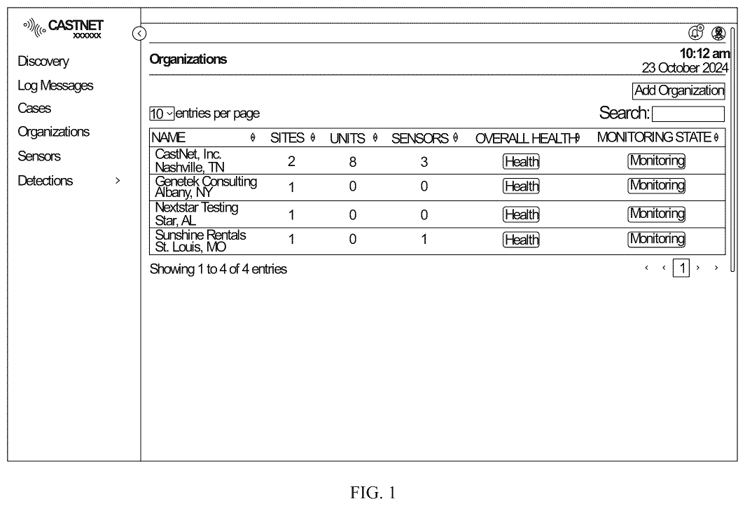

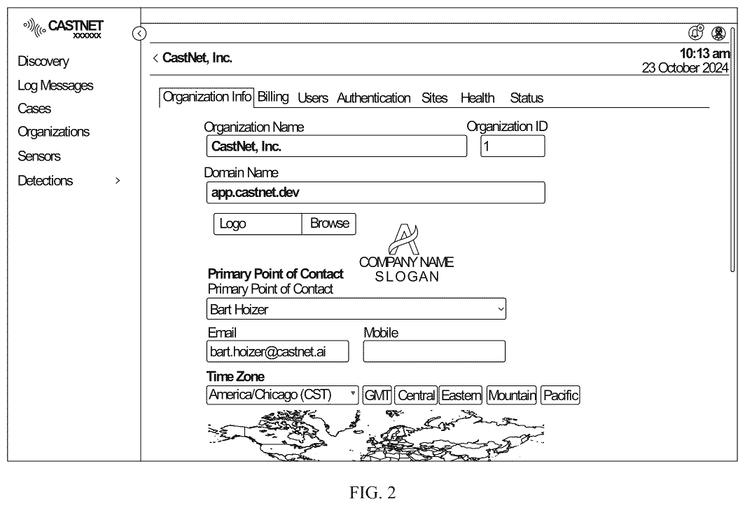

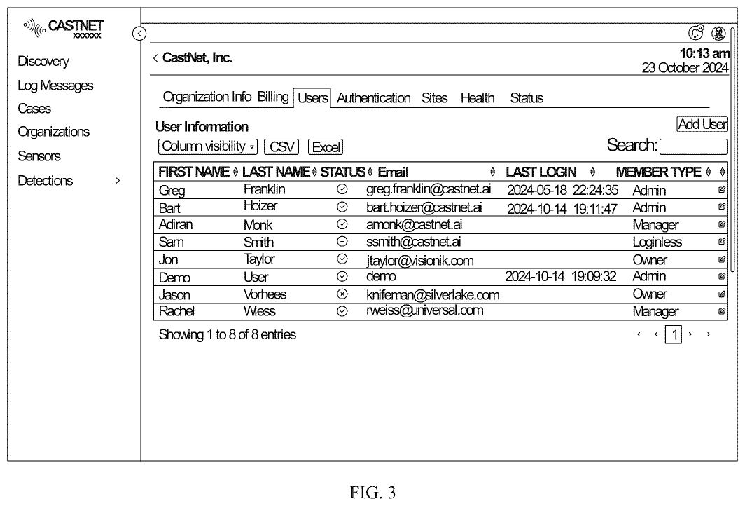

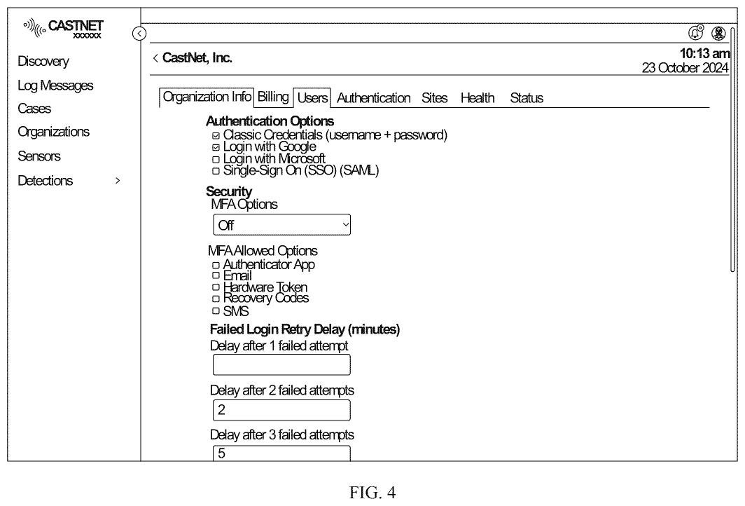

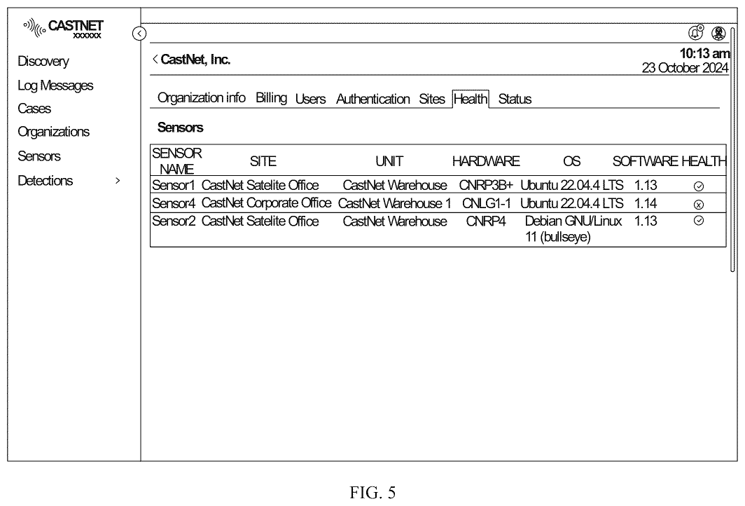

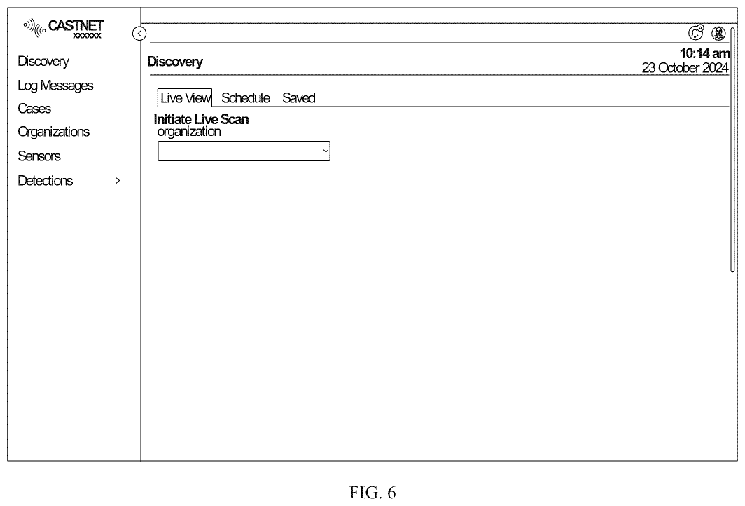

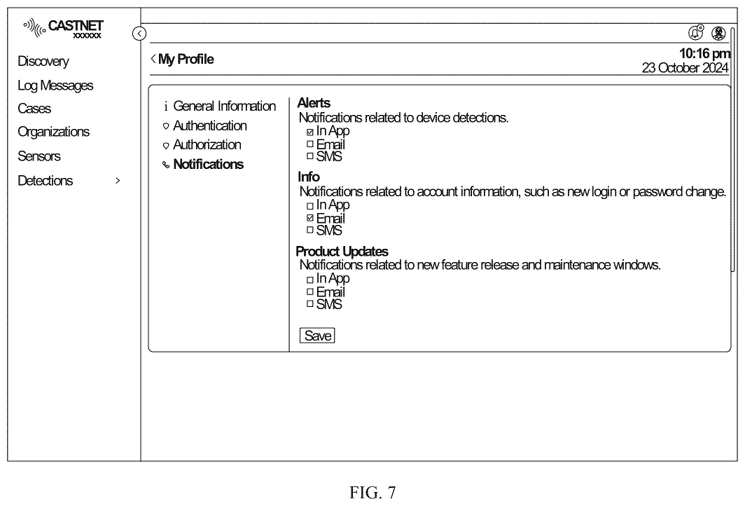

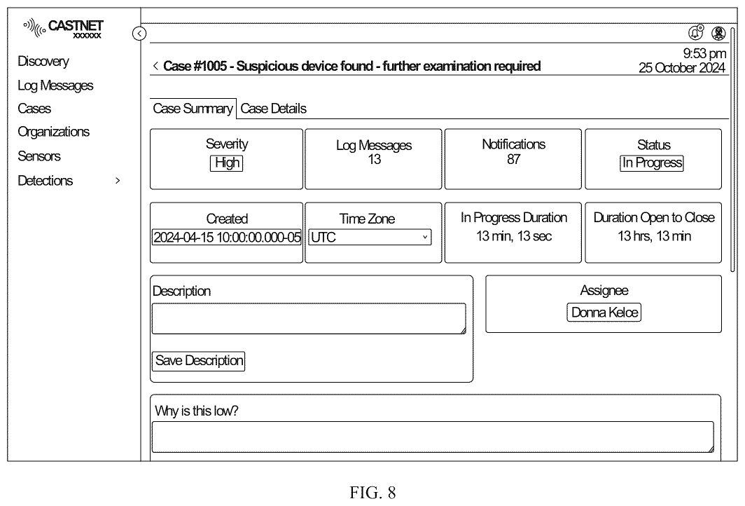

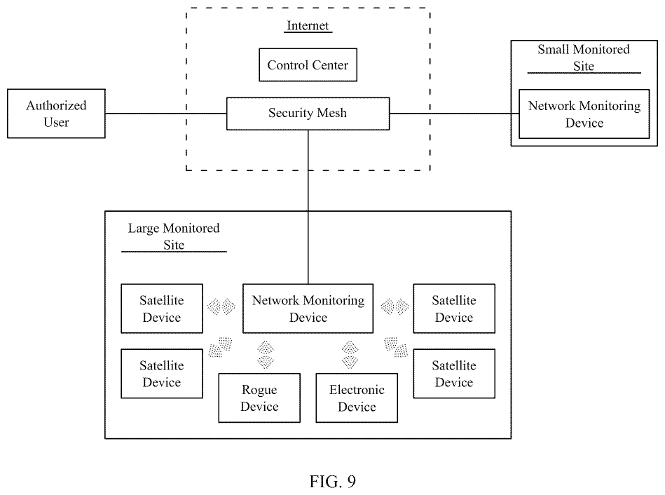

The present invention discloses a system and method for detecting rogue devices and implementing security measures on a communications network. The present invention allows the persistent monitoring of one or more communications networks to detect rogue devices using different detection methodologies. This allows the detection of different network elements including, but not limited to, traditional network devices, mobile electronic devices, recording devices, crowds, traffic, Internet of Things (IoT) devices, etc. As can be seen in FIG. 1 through 9, the system of the present invention includes a plurality of electronic devices and a plurality of network monitoring devices managed by at least one remote server (Step A). The electronic devices correspond to the devices connected to the communications networks being monitored by the present invention. The communication networks can include, but are not limited to, computer networks and wireless networks. The network monitoring devices include several proprietary and/or third-party monitoring devices that are utilized to monitor the signals being transmitted over the monitored communications networks.

In the preferred embodiment, the remote server enables the implementation of a cloud-based centralized command and control software application, also referred to as the control center, that enables the overall operation of the present invention. As can be seen in FIG. 1 through 9, the control center is a custom-built Software-as-a-Service (SaaS) application with inter-connectivity and Internet access via a secure mesh network of the system of the present invention. The mesh network is preferably an encrypted Virtual Private Network (VPN) that allows for secure communications between authorized users, the control center, and the network monitoring devices at the target locations. The mesh network utilizes an enterprise-grade Secure Access Service Edge (SASE) solution to control connectivity via secure tunnels and Internet services. Utilizing SASE allows for extensive control on what devices are allowed to connect and where data is allowed to flow. Further, the control center is accessible to the authorized users via the Internet and a web browser. The control center is multi-tenant, so authorized users may access all customer dashboards if given appropriate permissions. Each customer is contained within the corresponding tenant and assigned a role within the corresponding tenant that allows the customer to access the customer's organization information. Roles allow for restricting access to predetermined parts of the organization.

Further, the network monitoring devices include several small network appliances running Linux, several open-source tools and libraries, commercial software, and a custom software application. The network monitoring devices may be branded and built for overt display at the target location or to be installed covertly/discreetly. Further, the network monitoring devices may include several electronic components depending on the functionality selected by the user. For example, the network monitoring devices may include, but are not limited to, physical ethernet adapters, wireless ethernet adapters (Wi-Fi), broad-spectrum radio frequency adapter, narrow-band radio frequency adapter, Bluetooth adapter, cellular modem, etc. Further, each of the network monitoring devices may include several local databases that include, but are not limited to, control center tasking, devices discovered while scanning, detection methods, log messages, etc. In addition, each of the network monitoring devices can maintain software configurations and executables. Database, configuration files, and executables may be updated based on tasking received from the control center.

Each of the network monitoring devices record several information about the electronic devices discovered while scanning. For example, on a corresponding communications network, the network monitoring devices may record: the Machine Access Code (MAC) addresses of the discovered device, power level of the signal from the discovered device, Signal to Noise Ratio (SNR), time, traffic characteristics [e.g., Domain Name Services (DNS)], packet counts, session size and duration, etc. Further, the device software application updates local databases very frequently and reports relevant information to the control center. Both the network monitoring devices and the control center may issue an alert based on the detection methodologies established for the target location. Furthermore, the network monitoring devices may include a plurality of satellite devices. The satellite devices are ultrasmall form factor devices that extend the coverage of a network monitoring device. The satellite devices have very low power consumption and can perform few of the operational methods that a network monitoring device can perform. In general, each satellite device extends the reach of network monitoring devices. By connecting four or more satellite devices to a network monitoring device, direction finding and/or geolocation can be performed to identify a detected device location.

Furthermore, the system of the present invention includes a plurality of security countermeasures, a plurality of device classifications, a plurality of device risk levels, and a risk level threshold managed by the remote server (Step B), as can be seen in FIG. 1 through 9. The device classifications and the device risk levels facilitate the detection and analysis of the detected devices on a corresponding network. The device classifications preferably include a supported device classification, an unclassified device classification, and an unauthorized device classification. The risk level threshold corresponds to a predetermined threshold established by authorized users or the customer that helps determine when the appropriate security countermeasures need to be performed. The security countermeasures includes different methodologies designed to take care of a detected rogue device according to the device's risk to the corresponding network. In the preferred embodiment, the security countermeasures includes blocking a device network access, isolating a device on the corresponding communications network, disconnecting a device from the corresponding communications network, disrupting the device operation, or a combination thereof. Blocking network access to the detected rogue device can be done using the target location's firewall, intrusion prevention system (IPS), or switch. This would require the remote server to be connected to or have an integration with the location's firewall, intrusion prevention system (IPS), or switch. Similar to blocking network access to the detected device, isolating a device on the corresponding communications network would require a connection to or an integration with the location's firewall, intrusion prevention system (IPS), or switch. Disconnecting the detected device from the corresponding communications network would also require connection or integration with the location's network access points. However, the disconnection can also be performed by active engagement with the detected device to effect man-in-the-middle interference, such as DHCP spoofing, or to reset the rogue device's connection. Finally, disrupting the device operation can be performed by actively engaging the rogue device to interfere with the device's normal operation.

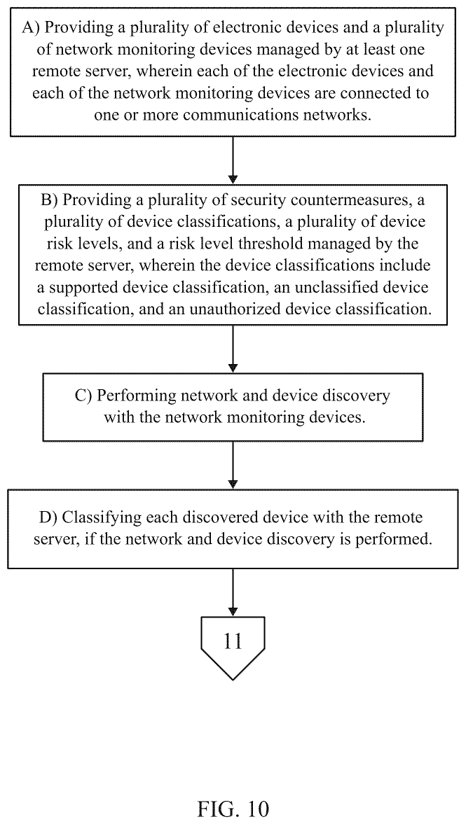

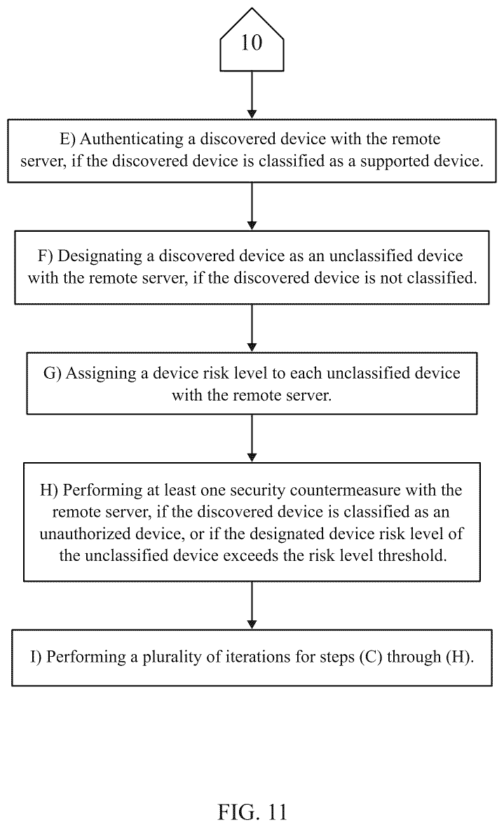

The system of the present invention allows the implementation of an automatic method of monitoring and detecting rogue devices in a persistent manner. As can be seen in FIGS. 10 and 11, the overall process of the method of the present invention begins by performing network and device discovery with the network monitoring devices (Step C) which enables the discovery of the communications networks available to the network monitoring devices as well as the electronic devices connected to the communications networks. Once the communications networks and the connected electronic devices are discovered, the remote server classifies each discovered device (Step D), if the network and device discovery is performed, in order to determine the type of device that was discovered. The classification of the electronic devices connected to the discovered communications networks are performed by analyzing different device factors including, but not limited to, the device's characteristics or heuristics. The device's characteristics can be the network addressing, signal spectrum, traffic pattern, etc. Classifying the discovered devices is generally a “best guess” of the type of the device that helps the system of the present invention to determine the best course of action according to the device's type and classification.

As can be seen in FIGS. 10 and 11, afterwards, a discovered device is authenticated with the remote server (Step E), if the discovered device is classified as a supported device. In other words, a discovered device that has been determined to be a supported device is whitelisted to normally operate in the communications network. Alternatively, a discovered device can be designated as an unclassified device with the remote server (Step F), if the discovered device is not classified. In other words, when the system of the present invention fails to classify the discovered device, the discovered device is automatically designated as unclassified so that the proper security measures can be performed. Once a discovered device is designated as unclassified, a device risk level is assigned to each unclassified device with the remote server (Step G) that helps the system of the present invention to determine if a security countermeasure needs to be performed. So, at least one security countermeasure is performed with the remote server (Step H), if the discovered device is classified as an unauthorized device, or if the designated device risk level of the unclassified device exceeds the risk level threshold. In other words, if the device risk level assigned to the unclassified device exceeds the risk level threshold, the system of the present invention automatically performs the appropriate security countermeasure. Likewise, if the discovered device is classified as an unauthorized device, the system of the present invention automatically performs the appropriate security countermeasures to protect the corresponding communications networks. Furthermore, a plurality of iterations for Steps C through H is performed (Step I) so that the monitoring and detection processes are performed in a persistent manner.

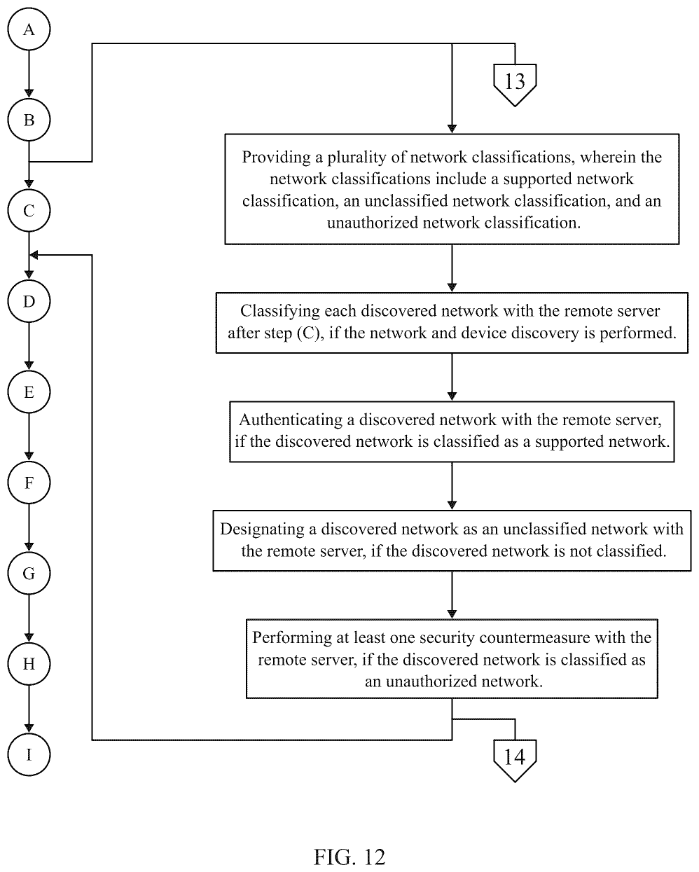

Similar to the classification of electronic devices, the communications networks discovered by the network monitoring devices can be classified to help the system of the present invention and the authorized users take the appropriate security measures. To do so, the system of the present invention may further include a plurality of network classifications that include a supported network classification, an unclassified network classification, and an unauthorized network classification. The unclassified network classification corresponds to a communications network that has not been previously classified. The supported network classification corresponds to a communications network that is owned and supported by the customer. The unauthorized network classification corresponds to a communications network that is previously known, and mitigation efforts must be made to locate and remove. As can be seen in FIG. 12, the subprocess of classifying discovered networks includes the steps of classifying each discovered network with the remote server after Step C, if the network and device discovery is performed. Similar to the classification of the discovered devices, the system of the present invention automatically detects and classifies the discovered networks in order to perform the appropriate security measures. Moreover, a discovered network is authenticated with the remote server, if the discovered network is classified as a supported network that has been previously whitelisted. Alternatively, a discovered network is designated as an unclassified network with the remote server, if the discovered network is not classified from previous network and device discoveries. Furthermore, at least one security countermeasure is performed with the remote server, if the discovered network is classified as an unauthorized network that needs to be mitigated.

The initial classification of communications networks is preferably a manual process that authorized users must perform for the efficient automatic detection of future communications networks that are automatically discovered by the system of the present invention. So, the system of the present invention may further include at least one authorized user account managed by the remote server that enables an authorized user to interact with the control center. As previously discussed, authorized users can access the control center via a webpage, so the authorized user account is associated with a corresponding user computing device that the user can utilize. In addition, the network classifications may further include an identified network classification and a suspicious network classification. The identified network classification corresponds to a communications network that has been previously identified and properly operates outside the owned and supported networks. The suspicious network classification corresponds to a network that has been determined to be unknown or unsupported but has not yet been deemed to be unauthorized.

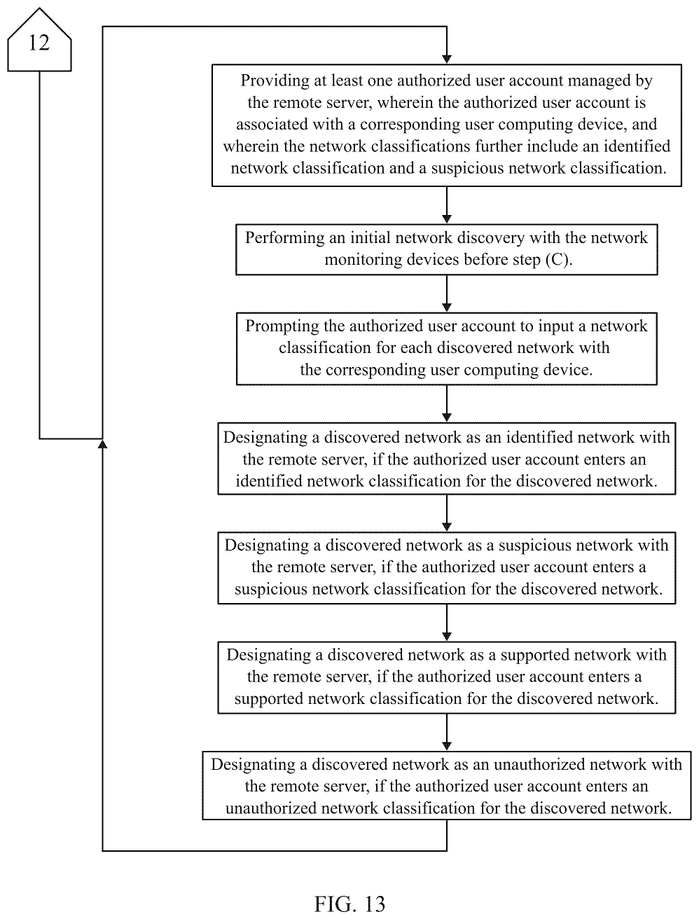

As can be seen in FIG. 13, the subprocess of manually classifying communications networks includes the steps of performing an initial network discovery with the network monitoring devices before Step C. The classification of communications networks is preferably performed once the network monitoring devices are installed for the system to have a foundation for future network discoveries. However, the authorized users can manually classify newly discovered networks for more accurate classifications. The authorized user account is prompted to input a network classification for each discovered network with the corresponding user computing device which is recorded by the remote server for future reference by the system of the present invention. Then, a discovered network is designated as an identified network with the remote server, if the authorized user account enters an identified network classification for the discovered network, as a suspicious network if the authorized user account enters a suspicious network classification, as a supported network if the authorized user account enters a supported network classification, or as an unauthorized network if the authorized user account enters an unauthorized network classification. In other embodiments, different network classifications can be implemented for more accurate assessments of discovered networks during the persistent monitoring of the target location.

As previously discussed, the network monitoring devices detect electronic devices and communications networks at a target location that transmit signals on hardwired Ethernet and/or in the radio wave spectrum. The network monitoring devices may detect electronic devices or networks that are only identified once but never again. So, to assist the authorized users in identifying all discovered networks and devices, the present invention may further include a plurality of network statuses managed by the remote server that corresponds to different persistence statuses of a communications network. The network statuses include, but are not limited to a new status, an ephemeral status, an intermittent status, and a persistent status. The new status corresponds to a communications network that has been regularly detected, with minimal gaps, in the past 30 days. The ephemeral status corresponds to a communications network that has been identified within the past day. The intermittent status corresponds to a communications network that is transitory and remains at a location for a short period of time. Moreover, the persistent status corresponds to a communications network that remains at a location for an extended period of time.

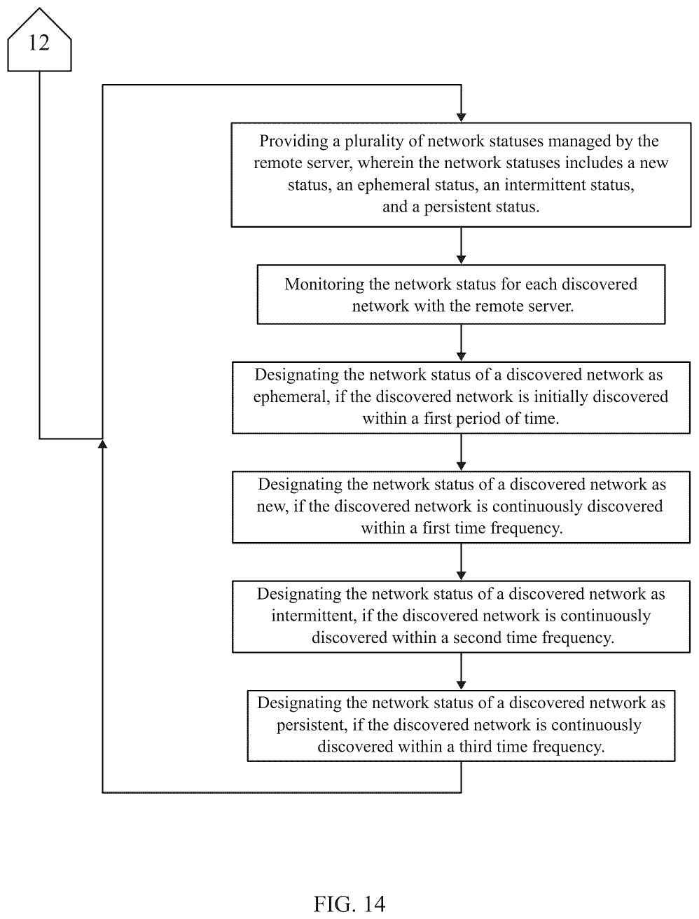

As can be seen in FIG. 14, the subprocess of monitoring and determining the network status of a discovered network includes the steps of monitoring the network status for each discovered network with the remote server. This subprocess is performed along the main process of the method of the present invention every Step C is performed. Then, the network status of a discovered network is designated as ephemeral, if the discovered network is initially discovered within a first period of time, as new if the discovered network is continuously discovered within a first time frequency, as intermittent if the discovered network is continuously discovered within a second time frequency, or as persistent if the discovered device is continuously discovered within a third time frequency.

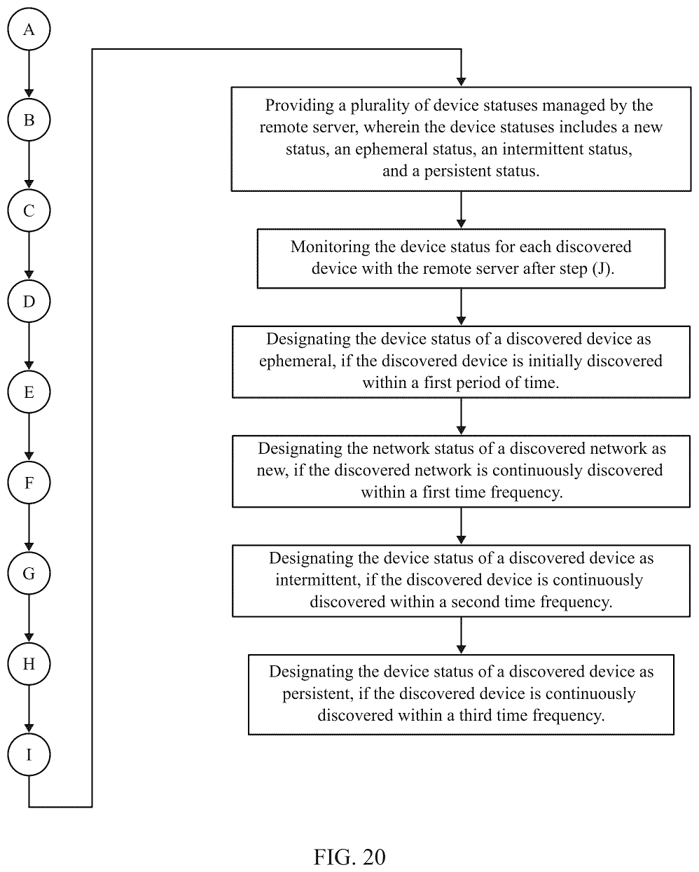

Furthermore similar to the network statuses, the present invention may further include a plurality of device statuses managed by the remote server that corresponds to different persistence statuses of an electronic device. The device statuses include, but are not limited to a new status, an ephemeral status, an intermittent status, and a persistent status, similar to the network statuses. As can be seen in FIG. 20, the subprocess of monitoring and determining the device status of a discovered device includes the steps of monitoring the device status for each discovered device with the remote server after Step J. This subprocess is performed after the discovered devices have been discovered and classified. Then, the device status of a discovered device is designated as ephemeral, if the discovered device is initially discovered within a first period of time, as new if the discovered device is continuously discovered within a first time frequency, as intermittent if the discovered device is continuously discovered within a second time frequency, or as persistent if the discovered device is continuously discovered within a third time frequency. Furthermore, the first period of time is preferably a day, the second time frequency is higher than the first time frequency, and the third time frequency is higher than the second time frequency. For example, the first time frequency can be a daily detection during a month, the second time frequency can be a weekly detection since the first discovery, and the third time frequency can be a daily detection since the first discovery. In other embodiments, different persistent statuses for the discovered networks can be implemented.

Similar to the initial classification of communications networks, the initial classification of electronic devices is preferably a manual process that authorized users must perform for the efficient automatic detection of future electronic devices that are automatically discovered by the system of the present invention. In addition, like the network classifications, the device classifications may further include an identified device classification and a suspicious device classification. The identified device classification corresponds to an electronic device that has been previously identified and properly operates outside the owned and supported networks. The suspicious device classification corresponds to an electronic device that has been determined to be unknown or unsupported but has not yet been deemed to be unauthorized.

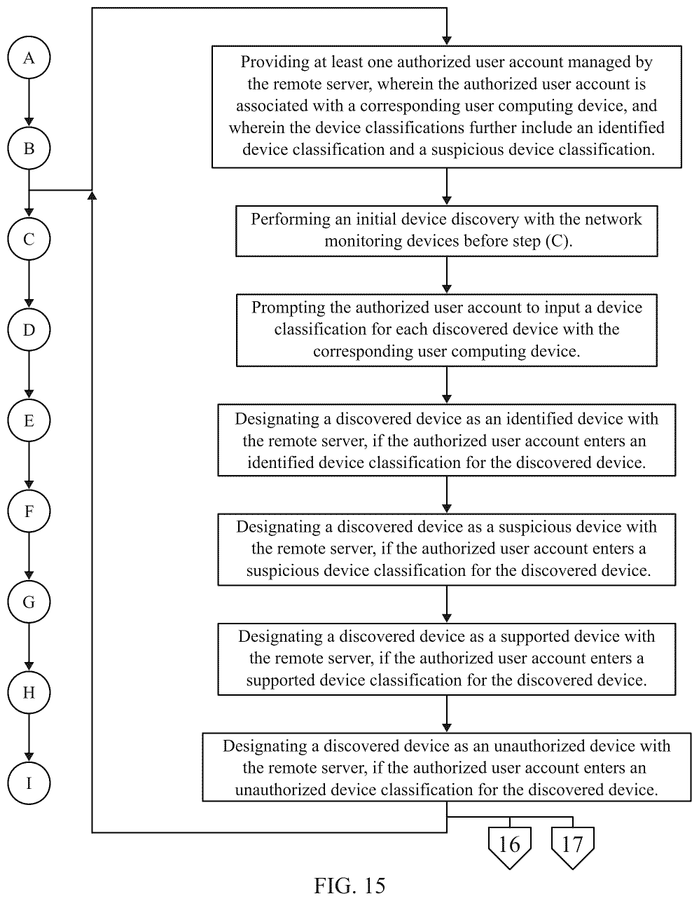

As can be seen in FIG. 15, the subprocess of manually classifying electronic devices includes the steps of performing an initial device discovery with the network monitoring devices before Step C. The classification of communications networks is preferably performed once the network monitoring devices have been installed for the system to have a foundation for future device discoveries. However, the authorized users can manually classify newly discovered devices for more accurate classifications. The authorized user account is prompted to input a device classification for each discovered device with the corresponding user computing device which is recorded by the remote server for future reference by the system of the present invention. Then, a discovered device is designated as an identified device with the remote server, if the authorized user account enters an identified device classification for the discovered device, as a suspicious device if the authorized user account enters a suspicious device classification, as a supported device if the authorized user account enters a supported device classification, or as an unauthorized device if the authorized user account enters an unauthorized device classification. In other embodiments, different device classifications can be implemented for more accurate assessments of discovered device during the persistent monitoring of the target location.

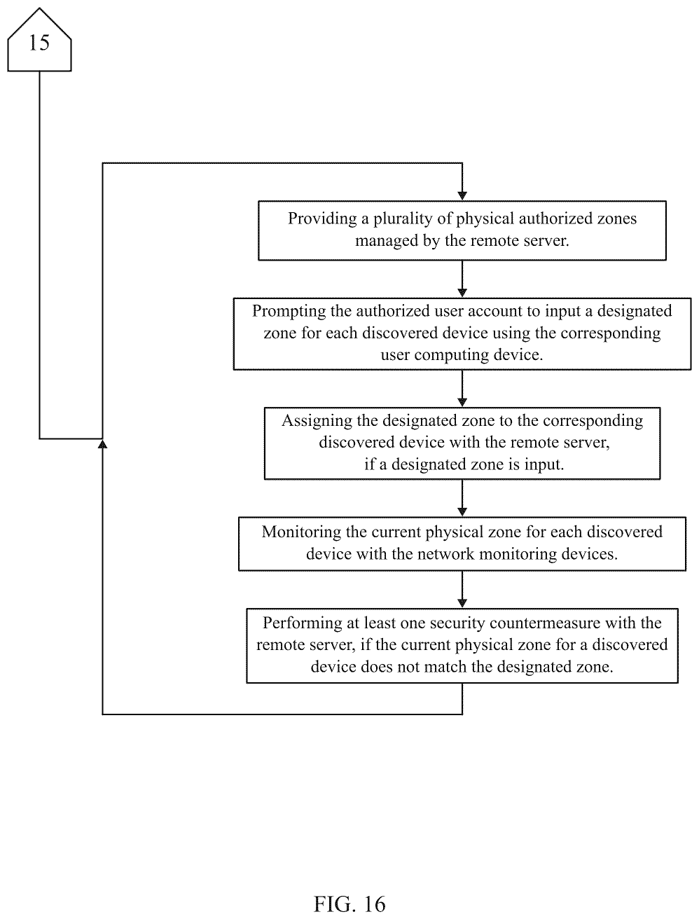

To improve the security of the target location, the system of the present invention enables the assignment of zones to the discovered devices corresponding to physical zones at the target location that the discovered devices are allowed to operate in. To do so, the system of the present invention includes a plurality of physical authorized zones managed by the remote server. The physical authorized zones are stored on the remote server for automatic detection of unauthorized movement of an electronic device from an authorized zone to an unauthorized zone within the target location. As can be seen in FIG. 16, the subprocess of assigning and monitoring an authorized zone for a discovered device includes the steps of prompting the authorized user account to input a designated zone for each discovered device using the corresponding user computing device. The authorized user can assign the discovered device an authorized zone during the initial discovery or during future discoveries. Authorized users can also edit zone assignments by accessing the control center. Moreover, the designated zone is assigned to the corresponding discovered device with the remote server if the authorized user input a designated zone. The current physical zone for each discovered device is then continuously monitored with the network monitoring devices. Furthermore, at least one security countermeasure is performed with the remote server, if the current physical zone for a discovered device does not match the designated zone. In other embodiments, different geophysical tracking methods can be implemented.

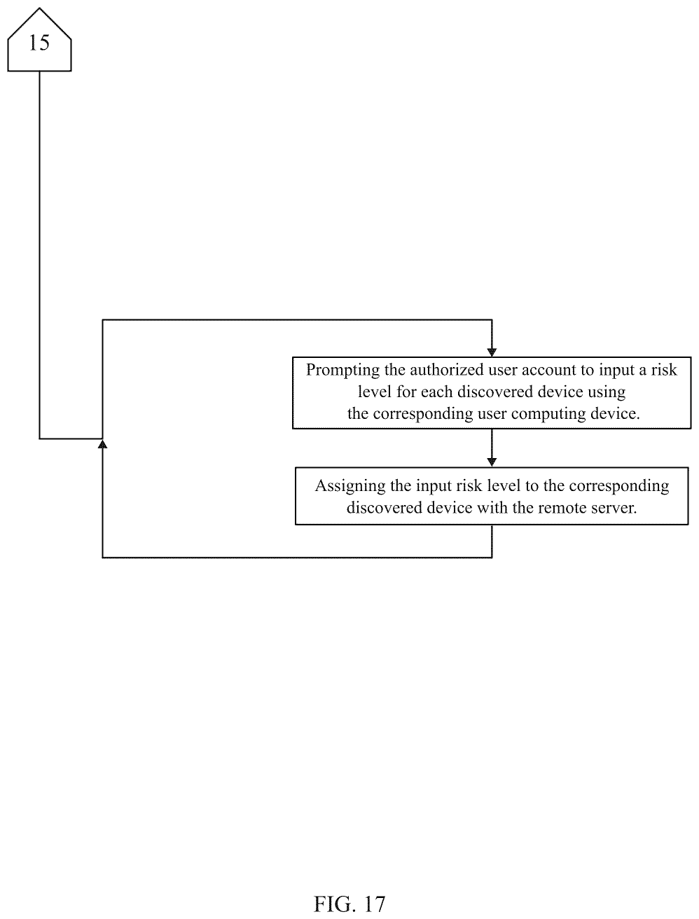

As previously discussed, the system of the present invention utilizes risks levels to determine when appropriate security countermeasures need to be performed. Authorized users can assign risk levels to known electronic devices to allow the system of the present invention to automatically detect potential risks to the corresponding communications networks. As can be seen in FIG. 17, the subprocess of assigning risk levels to discovered devices includes the steps of prompting the authorized user account to input a risk level for each discovered device using the corresponding user computing device. The system of the present invention can also utilize external sources, such as public or private device databases, to determine the risk levels of the discovered devices. Then, the input risk level is assigned to the corresponding discovered device with the remote server for future reference when discovering new electronic devices.

The discovery and classification of new electronic devices is automatically performed by the system of the present invention so that potential threats to the corresponding communications networks are promptly addressed. Overall, when a new electronic device is discovered, the system of the present invention tries to identify the discovered device as well as the device's traffic pattern. In addition, the system of the present invention performs a series of identification tests to determine a likely device type, applies a series of confidence scores to the results of the identification tests, and determines an overall confidence level for declaring that the discovered device is the likely device type. The identification process is applied to unclassified devices but may be re-applied to determine a more likely device type. Furthermore, the identification tests and the confidence scores are affiliated with one or more device types.

In the preferred embodiment, when a new electronic device is discovered, the discovered device is designated as an unclassified device so that each new electronic device is analyzed by the system of the present invention to determine the device type of the discovered device. To do so, the identification tests correspond to a plurality of device identification tests managed by the remote server. Each device identification test outputs a point value result and a device type result that are used to determine the most likely device type. As previously discussed, the device identification tests can include passive methods, active methods, and heuristic methods that can help determine the most likely device type. In the preferred embodiment, the default device identification test includes passive listening to communications at a physical location. These passive methods implies listen-only activities, meaning that the network monitoring devices do not actively engage with or otherwise disrupt the operation of the discovered electronic devices.

On the other hand, the active methods of the device identification tests include more assertive methods of device identification and interaction, such as polling the electronic devices, connecting to the electronic device ports, logging into the electronic device, and forcing the electronic device off the corresponding communications network. The active methods implies interaction with the discovered devices which could cause disruption to the discovered devices. So, active methods are only performed when a customer has authorized, and has the legal authority to authorize, the necessary active methods. Passive and active methods require short-term data processing and storage. On the other hand, heuristic methods require long-term data processing and storage but result in advanced device type determination and confidence scoring. For example, a network monitoring device can track the traffic profile of a suspected camera device to determine the network flow and calculate the duration, volume, and direction of traffic over a period of time.

In an exemplary embodiment, active methods of device identification tests can include actively connecting to an open network port associated with video streaming or acquiring video stream from an open network port. Heuristic methods of device identification tests can include analysis of Internet traffic statistics to determine large outbound network flow (egress), analysis of intra-network traffic statistics to determine large lateral network low (intra-network), or analysis of intra-network traffic statistics. Passive methods of device identification tests can include comparisons of the electronic device's MAC address to published lists of MAC addresses, private/proprietary of MAC addresses, identification of protocols operating on frequency bands used by droves, web application/browser name and version, platform/operating system, browser engine, additional libraries or features, DHCP option 55, DHCP option 12, DHCP option 60, DHCP option 61, DHCP option 43, DHCP message type, domain name analysis for different device brands, SSIDs identified, network protocols, frequency bands, etc. Furthermore, several methods can be used as passive or active methods such as TCP/IP header analysis, ICMP responses, etc. In other embodiments, different methods of device identification tests can be implemented.

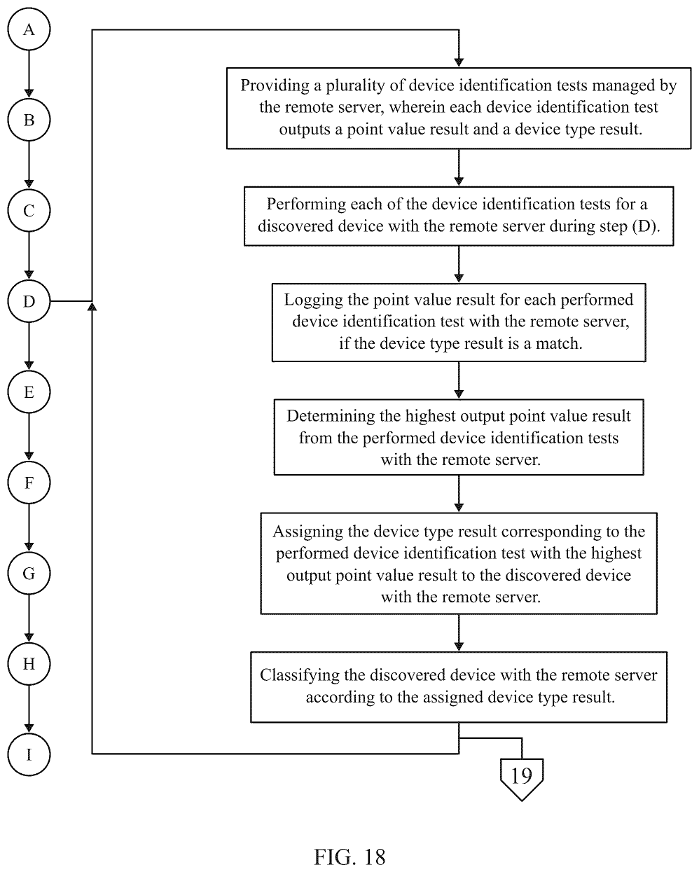

As can be seen in FIG. 18, the subprocess of detecting the likely device type of the discovered device includes the steps of performing each of the device identification tests for a discovered device with the remote server during Step D. When an unclassified device is identified by the system of the present invention, such as a new device, each identification test is performed by the remote server to determine the most likely device type. Further, the point value result is logged for each performed device identification test with the remote server, if the device type result is a match. In other words, the point value result of a device identification test is recorded when the device type result matches the discovered device. For example, if the discovered device is a camera and the device type result is a computer, the point value result is not considered. Then, the highest output point value result is determined from the performed device identification tests with the remote server. The point value results preferably include a value range from zero to ten, with ten being the highest point value for a device type result. Further, the device type result corresponding to the performed device identification test with the highest output point value result is assigned to the discovered device with the remote server. This way, the device type result with the highest point value is assigned to the unclassified device as the most likely device type. As a result, the discovered device with the remote server is classified according to the assigned device type result. Discovered devices can be compared against many device types as necessary to identify the most likely device type, or the authorized user can manually specify the device type using the control center.

Few device identification tests can, alone, positively identify an electronic device. In many cases, there may be uncertainty around the identification of a particular device type. So, after the several device identification tests are performed and a device type is proposed, a series of scorings are applied to calculate an overall confidence score. The overall confidence score can be used to make determinations as to any alerting that needs to occur if the overall confidence score is not acceptable. Different confidence scores can be assigned to each device identification test so positive matches do not add the same level of confidence to other scores.

Further, different types of scores can be implemented to calculate the overall confidence score of the likely device type of the discovered device. So, the system of the present invention can include a plurality of total confidence scores, a plurality of individual confidence scores, a plurality of concurrent confidence scores, and at least one confidence score threshold managed by the remote server. The total confidence scores correspond to the confidence score that is used to determine if the likely device type is an appropriate determination. The individual confidence scores corresponds to simple matches where if the discovered device display a particular characteristic, then scoring points are applied. Concurrent confidence scores correspond to the combination of two or more individual confidence scores matched for the same device. Furthermore, the confidence scores utilize a ten-point system, and the total confidence scores are displayed as rounded up score to the authorized user.

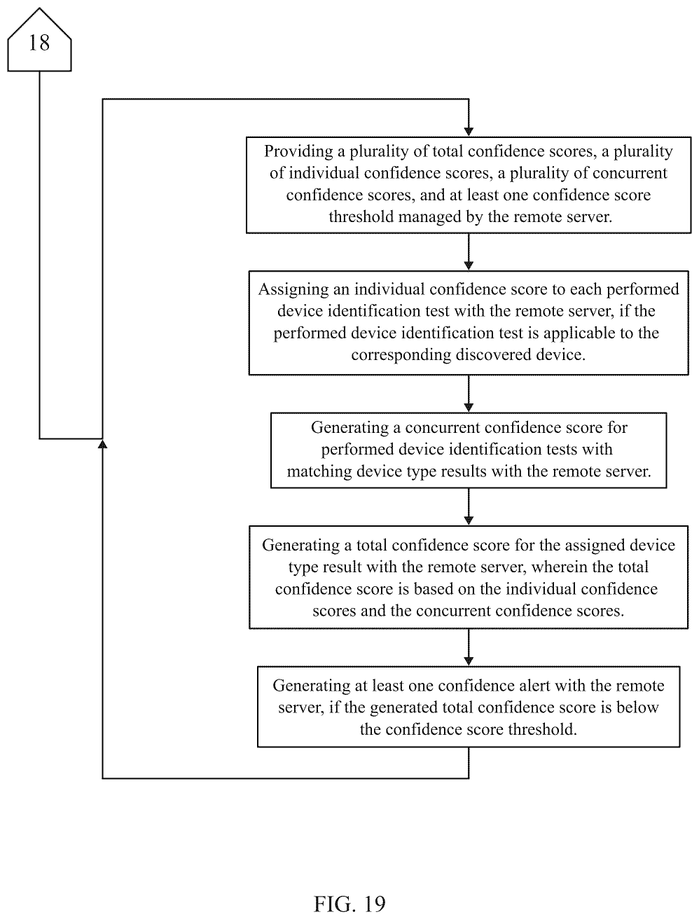

As can be seen in FIG. 19, the subprocess of determining the total confidence scores for each discovered device includes the steps of assigning an individual confidence score to each performed device identification test with the remote server, if the performed device identification test is applicable to the corresponding discovered device. In other words, because not all device identification tests are applicable to all electronic devices, only applicable device identification tests are taken into consideration. Further, a concurrent confidence score is generated for performed device identification tests with matching device type results with the remote server. Once the individual confidence scores and the concurrent confidence scores are determined for the applicable device identification tests, a total confidence score for the assigned device type result is generated with the remote server, wherein the total confidence score is based on the individual confidence scores and the concurrent confidence scores.

In the preferred embodiment, the total confidence scores are calculated by implementing the following formula:

$${C}_{t} = Round ( Min ( 10 , {P}_{max} + ( \frac{{P}_{a} - {P}_{max}}{{P}_{t} - {P}_{max}} ) * ( 10 - {P}_{max} ) ) )$$

Where Cₜ corresponds to the total confidence score, Pₘₐₓ corresponds to the highest output point value, Pₐ corresponds to the assigned confidence score, and Pₜ corresponds to the total possible confidence score. The total possible confidence score is calculated by summing up all the applicable individual confidence scores and the concurrent confidence scores. The assigned confidence score is calculated by summing up all the applicable and matched confidence scores. The highest output point value corresponds to the maximum of all applicable and matched confidence scores.

Furthermore, the total confidence score is rounded up to display a whole number, which preferably falls in a number scale of zero to ten, where zero corresponds to a newly discovered device, the device behavior could not be analyzed, and there is no confidence that the assigned device type result is true. On the other end, ten corresponds to an overall positive confidence score, with full confidence that the assigned device type is true. Authorized users can implement the confidence score threshold appropriate to the target location. Using the confidence score threshold can be used to generate at least one confidence alert with the remote server, if the generated total confidence score is below the confidence score threshold. The confidence alert can be output to the authorized users so that the authorized users can perform the necessary security measures. In other embodiments, different methodologies can be utilized to determine the most likely device type as well as the overall confidence score.

In addition to the automatic detection and classification of the discovered devices, the control center enables the implementation of a case management function. Cases may be created automatically or by authorized users in the control center. Logs are attached to cases in the case details and contain specific information that triggered the case or are associated with the case by the user. Logs attached to cases are never deleted as long as the case is in the control center. A case summary feature is included for each case, which allows the display of the case information in a better-presented format to note the high-level information about the case. For example, the case information can include, but is not limited to, case severity, number of log messages, number of notifications, case status, date created, time zone, progress duration, duration from open to close, description, assigned user, timeline, comments/history, etc. Case severity includes different levels including, but not limited to, notice, low, medium, and high. Case status also includes different levels including, but not limited to, new, in progress, escalated, and closed. In other embodiments, different features can be implemented by the system of the present invention including, but not limited to, direction finding, video acquisition, active removal of suspicious devices from the corresponding networks, actively crash suspicious devices, etc.

Although the invention has been explained in relation to its preferred embodiment, it is to be understood that many other possible modifications and variations can be made without departing from the spirit and scope of the invention.

What is claimed is:

1. A method for detecting rogue devices and implementing security measures on a communications network, the method comprising the steps of:
A) providing a plurality of electronic devices and a plurality of network monitoring devices managed by at least one remote server, wherein each of the electronic devices and each of the network monitoring devices are connected to one or more communications networks;
B) providing a plurality of security countermeasures, a plurality of device classifications, a plurality of device risk levels, and a risk level threshold managed by the remote server, wherein the device classifications include a supported device classification, an unclassified device classification, and an unauthorized device classification;
C) performing network and device discovery with the network monitoring devices;
D) classifying each discovered device with the remote server, if the network and device discovery is performed;
E) authenticating a discovered device with the remote server, if the discovered device is classified as a supported device;
F) designating a discovered device as an unclassified device with the remote server, if the discovered device is not classified;
G) assigning a device risk level to each unclassified device with the remote server;
H) performing at least one security countermeasure with the remote server, if the discovered device is classified as an unauthorized device, or if the designated device risk level of the unclassified device exceeds the risk level threshold; and
I) performing a plurality of iterations for steps (C) through (H).

2. The method as claimed in claim 1 further comprising the steps of:
providing a plurality of network classifications, wherein the network classifications include a supported network classification, an unclassified network classification, and an unauthorized network classification;
classifying each discovered network with the remote server after step (C), if the network and device discovery is performed;
authenticating a discovered network with the remote server, if the discovered network is classified as a supported network;
designating a discovered network as an unclassified network with the remote server, if the discovered network is not classified; and
performing at least one security countermeasure with the remote server, if the discovered network is classified as an unauthorized network.

3. The method as claimed in claim 2 further comprising the steps of:
providing at least one authorized user account managed by the remote server, wherein the authorized user account is associated with a corresponding user computing device, and wherein the network classifications further include an identified network classification and a suspicious network classification;
performing an initial network discovery with the network monitoring devices before step (C);
prompting the authorized user account to input a network classification for each discovered network with the corresponding user computing device;
designating a discovered network as an identified network with the remote server, if the authorized user account enters an identified network classification for the discovered network;
designating a discovered network as a suspicious network with the remote server, if the authorized user account enters a suspicious network classification for the discovered network;
designating a discovered network as a supported network with the remote server, if the authorized user account enters a supported network classification for the discovered network; and
designating a discovered network as an unauthorized network with the remote server, if the authorized user account enters an unauthorized network classification for the discovered network.

4. The method as claimed in claim 2 further comprising the steps of:
providing a plurality of network statuses managed by the remote server, wherein the network statuses includes a new status, an ephemeral status, an intermittent status, and a persistent status;
monitoring the network status for each discovered network with the remote server;
designating the network status of a discovered network as ephemeral, if the discovered network is initially discovered within a first period of time;
designating the network status of a discovered network as new, if the discovered network is continuously discovered within a first time frequency;
designating the network status of a discovered network as intermittent, if the discovered network is continuously discovered within a second time frequency; and
designating the network status of a discovered network as persistent, if the discovered network is continuously discovered within a third time frequency.

5. The method as claimed in claim 4, wherein the first period of time is a day, the second time frequency is higher than the first time frequency, and the third time frequency is higher than the second time frequency.

6. The method as claimed in claim 1 further comprising the steps of:
providing at least one authorized user account managed by the remote server, wherein the authorized user account is associated with a corresponding user computing device, and wherein the device classifications further include an identified device classification and a suspicious device classification;
performing an initial device discovery with the network monitoring devices before step (C);
prompting the authorized user account to input a device classification for each discovered device with the corresponding user computing device;
designating a discovered device as an identified device with the remote server, if the authorized user account enters an identified device classification for the discovered device;
designating a discovered device as a suspicious device with the remote server, if the authorized user account enters a suspicious device classification for the discovered device;
designating a discovered device as a supported device with the remote server, if the authorized user account enters a supported device classification for the discovered device; and
designating a discovered device as an unauthorized device with the remote server, if the authorized user account enters an unauthorized device classification for the discovered device.

7. The method as claimed in claim 6 further comprising the steps of:
providing a plurality of physical authorized zones managed by the remote server;
prompting the authorized user account to input a designated zone for each discovered device using the corresponding user computing device;
assigning the designated zone to the corresponding discovered device with the remote server, if a designated zone is input;
monitoring the current physical zone for each discovered device with the network monitoring devices; and
performing at least one security countermeasure with the remote server, if the current physical zone for a discovered device does not match the designated zone.

8. The method as claimed in claim 6 further comprising the steps of:
prompting the authorized user account to input a risk level for each discovered device using the corresponding user computing device; and
assigning the input risk level to the corresponding discovered device with the remote server.

9. The method as claimed in claim 1 further comprising the steps of:
providing a plurality of device identification tests managed by the remote server, wherein each device identification test outputs a point value result and a device type result;
performing each of the device identification tests for a discovered device with the remote server during step (D);
logging the point value result for each performed device identification test with the remote server, if the device type result is a match;
determining the highest output point value result from the performed device identification tests with the remote server;
assigning the device type result corresponding to the performed device identification test with the highest output point value result to the discovered device with the remote server; and
classifying the discovered device with the remote server according to the assigned device type result.

10. The method as claimed in claim 9 further comprising the steps of:
providing a plurality of total confidence scores, a plurality of individual confidence scores, a plurality of concurrent confidence scores, and at least one confidence score threshold managed by the remote server;
assigning an individual confidence score to each performed device identification test with the remote server, if the performed device identification test is applicable to the corresponding discovered device;
generating a concurrent confidence score for performed device identification tests with matching device type results with the remote server;
generating a total confidence score for the assigned device type result with the remote server, wherein the total confidence score is based on the individual confidence scores and the concurrent confidence scores; and
generating at least one confidence alert with the remote server, if the generated total confidence score is below the confidence score threshold.

11. The method as claimed in claim 1, wherein the security countermeasures includes blocking a device network access, isolating a device on the corresponding communications network, disconnecting a device from the corresponding communications network, disrupting the device operation, or a combination thereof.

12. The method as claimed in claim 1 further comprising the steps of:
providing a plurality of device statuses managed by the remote server, wherein the device statuses includes a new status, an ephemeral status, an intermittent status, and a persistent status;
monitoring the device status for each discovered device with the remote server after step (J);
designating the device status of a discovered device as ephemeral, if the discovered device is initially discovered within a first period of time;
designating the device status of a discovered device as new, if the discovered device is continuously discovered within a first time frequency;
designating the device status of a discovered device as intermittent, if the discovered device is continuously discovered within a second time frequency; and
designating the device status of a discovered device as persistent, if the discovered device is continuously discovered within a third time frequency.

13. The method as claimed in claim 12, wherein the first period of time is a day, the second time frequency is higher than the first time frequency, and the third time frequency is higher than the second time frequency.
